(19) United States
(12) Patent Application Publication
(10) Pub. No.: US 2025/0182505 A1
(43) Pub. Date: Jun. 5, 2025

(54) AI-INTEGRATED SYSTEMS, METHODS, AND COMPUTER-READABLE MEDIA FOR CHARACTERIZING MICROSPHERIC MATERIAL

(71) Applicant: BASF CORPORATION, FLORHAM PARK, NJ (US)

(72) Inventors: Karl C. Kharas, Dublin, OH (US); Ke-Bin Low, East Brunswick, NJ (US); Chansoon Kang, Parlin, NJ (US); Melissa Clough Mastry, San Diego, CA (US)

(73) Assignee: BASF CORPORATION, FLORHAM PARK, NJ (US)

(21) Appl. No.: 18/841,698

(22) PCT Filed: Mar. 6, 2023
(86) PCT No.: PCT/US2023/014569

§ 371 Date: Aug. 27, 2024

Related U.S. Application Data
(60) Provisional application No. 63/269,034, filed on Mar. 8, 2022.

(51) Int. Cl. G06V 20/69; G06T 3/4038; G06V 10/82

(52) U.S. Cl. CPC G06V 20/698; G06T 3/4038; G06V 10/82

(57) ABSTRACT

Methods, systems, and computer readable media are disclosed for providing a microsphere analysis tool (MAT). The method includes: (a) receiving image data representative of microscopic, spectroscopic, or a combination of microscopic and spectroscopic image data of a microspheric material; (b) segmenting the image data into tiled image regions; (c) stitching the tiled image regions into a composite image; (d) classifying, by a trained machine-learning model, each of the tiled image regions as corresponding to one of: (i) a particle, (ii) an intra-particle pore, or (iii) an inter-particle void; and (e) characterizing at least one of the (i) composition, (ii) composition-specific size distribution, (iii) crystalline phase, (iv) degree of crystallinity, or (v) crystallite-specific size distribution of the microspheric material.

### CROSS-REFERENCE TO RELATED APPLICATION(S)

This application claims the benefit of priority of U.S. Provisional Patent Application No. 63/269,034, filed Mar. 8, 2022, the disclosure of which is hereby incorporated by reference herein in its entirety.

### FIELD OF THE DISCLOSURE

This disclosure relates to systems, methods, and computer-readable media for acquiring microscopic and spectroscopic image data of a microspheric material, classifying image data of a microspheric material, and characterizing the compositional and structural properties of a microspheric material based on image data.

### BACKGROUND

Cracking is a process used for breaking complex organic molecules, such as high-molecular weight hydrocarbons, into simpler molecules by inducing the scission of carbon-carbon bonds, which typically occurs in the presence of a catalyst. The rate of cracking and the nature of the end products are dependent on the conditions under which the process is carried out, such as temperature, pressure, choice of chemical feedstock, as well as the properties of the catalysts and catalyst support materials.

The catalytic cracking process involves the presence of acid catalysts (usually solid acids such as alumina, silica-alumina, and zeolites), which promote a heterolytic cleavage of bonds yielding pairs of ions of opposite charges, usually a carbocation and a very unstable hydride anion. Carbon-localized free radicals and cations are both highly unstable and undergo processes of chain rearrangement, C-C scission in position beta (i.e., cracking) and intra- and intermolecular hydrogen transfer or hydride transfer. In both types of processes, the corresponding reactive intermediates (radicals, ions) are permanently regenerated, and thus they proceed by a self-propagating chain mechanism. The chain of reactions is eventually terminated by radical or ion recombination.

One widely used cracking process is Fluid Catalytic Cracking (FCC), which typically employs microspheric catalyst particles suspended in a rising flow of feed hydrocarbons to form a fluidized bed. Typical FCC catalysts contain active crystalline aluminosilicates, principally the faujasite zeolites (e.g., Y zeolite in its various forms such as REY, HY, REHY, USY, REUSY), to improve yield of liquified petroleum gas (LPG), LPG olefins, such as propylene and butylene, and/or light cycle oil (LCO).

In some instances, the zeolite(s) used as the active cracking component and any active inorganic oxide matrix components will be composited in the particles with a binder generally formed from an amorphous gel or sols such as silica sol, which acts to bind the components together on drying. The binder itself may or may not have activity. Fillers such as clays of the kaolin type make up the balance of the catalyst composition. The oxide matrix materials may be attrition resistant, selective with regard to the production of hydrocarbons without excessive coke make, and not readily deactivated by metals. Matrices with cracking activity (active matrices) may be formed to assist in the overall cracking reaction.

In other instances, the zeolite itself acts as a binder and may be the only binder material present. Such FCC catalysts are described in D. M. Stockwell's “Continuous Age Distribution Method for Catalytic Cracking. 1. Proof of Principle” Ind. Eng. Chem. Res. 2015, 54, pp. 5921-593. In the in-situ process, an active matrix, which may be calcined kaolin clay or alumina, is mixed with kaolin clay and spray dried to make microspheres. Metakaolin is produced from kaolinite by calcination. The Y zeolite is crystallized using metakaolin, and silica is leached from calcined clay. If needed, additional silica, caustic, and seeds are added to the crystallization reactor. The Y zeolite in the resulting in situ crystallized microsphere becomes an acid catalyst and also serves to bind the microsphere together. Incorporated FCC catalysts and additives, such as ZSM-5 additives, often contain kaolin clay as a filler. In situ microspheres do not have kaolin clay as a filler because the kaolin initially present becomes metakaolin after microsphere calcination, and that metakaolin is a reactant to make Y zeolite.

Pores are typically classified according to their sizes: (i) pores with widths exceeding about 50 nm (0.05 pm) are called macropores; (ii) pores of widths between 2 nm and 50 nm are called mesopores; (iii) pores with widths not exceeding about 2 nm are called micropores. K. S. W. Sing et al. “Reporting Physisorption Data for Gas/Solid Systems with Special Reference to the Determination of Surface Area and Porosity (Recommendations 1984)” Pure & Appl. Chem., 1985, Vol. 57, No. 4, pp. 603-619. Mercury porosity is often used to characterize macroporosity in FCC and other catalysts. Pores larger than 2 m diameter (20,000 Å) are typically considered to be interparticle pores. However, mercury porosimetry cannot distinguish between large intra-particle macropores and the interparticle space.

In addition, it is necessary to monitor and characterize FCC catalysts to have a better understanding of catalytic activity and product selectivity. A variety of characteristics of the FCC catalyst such as porosity, attrition resistance, elemental composition, crystalline phase, particle size distribution, and tolerance of contaminants, such as nickel, vanadium, copper, and iron, all play a role in catalytic activity and product selectivity. It is difficult and time consuming to accurately characterize the FCC catalysts in a given industrial or power generation application. This makes it onerous to analyze and optimize the performance of FCC catalysts.

### SUMMARY

This disclosure presents a microsphere analysis tool (MAT), which provides tools and methods for data analysis and mining of composite images of microspheric materials by a trained machine-learning model. More particularly, the MAT performs methods, comprising: (a) receiving image data representative of microscopic, spectroscopic, or a combination of microscopic and spectroscopic image data of a microspheric material; (b) segmenting the image data into tiled image regions; (c) stitching the tiled image regions into a composite image; (d) classifying, by a trained machine-learning model, each of the tiled image regions as corresponding to one of: (i) a particle, (ii) an intra-particle pore, or (iii) an inter-particle void; and (e) characterizing at least one of the (i) composition, (ii) composition-specific size distribution, (iii) crystalline phase, (iv) degree of crystallinity, or (v) crystallite-specific size distribution of the microspheric material.

In at least one embodiment, the tiled image data is obtained by scanning electron microscopy (SEM).

In at least one embodiment, the tiled image data is obtained by cross-sectional scanning electron microscopy.

In at least one embodiment, the tiled image data is obtained by backscatter electron scanning electron microscopy (BSE-SEM).

In at least one embodiment, the tiled image data is obtained by transmission electron spectroscopy (TEM).

In at least one embodiment, the tiled image data is obtained by cross-sectional transmission electron spectroscopy.

In at least one embodiment, the tiled image data is obtained by energy dispersive X-ray spectroscopy (EDX).

In at least one embodiment, the tiled image data is two-dimensional image data.

In at least one embodiment, the tiled image data is three-dimensional image data.

In at least one embodiment, the tiled image data is acquired in a partially automated process.

In at least one embodiment, the tiled image data is acquired in a fully automated process.

In at least one embodiment, the tiled image data is acquired in an unsupervised process.

In at least one embodiment, the tiled image data is acquired by grid segmentation in a row-column pattern. In at least one embodiment, the tiled image data comprises partially overlapping image tiles. In at least one embodiment, the partially overlapping image tiles overlap between 5% and 20%.

In at least one embodiment, the tiled image data is stitched into a composite image by a trained machine-learning model.

In at least one embodiment, the tiled image data is acquired at a magnification between the range of 100× and 6,000×.

In at least one embodiment, the tiled image data is acquired at a magnification between the range of 100× and 1,000×.

In at least one embodiment, the tiled image data is acquired at a magnification between the range of 250× and 550×.

In at least one embodiment, the tiled image data is acquired at a magnification between the range of 1,000× and 6,000×.

In at least one embodiment, the tiled image data is acquired at a magnification between the range of 4,000× and 5,500×.

In at least one embodiment, the tiled image data is acquired at a magnification between the range of 20,000× and 500,000×.

In at least one embodiment, the tiled image data includes microscopic images and spectroscopic images obtained at substantially the same magnification.

In at least one embodiment, the tiled image data includes microscopic images and spectroscopic images obtained at substantially the same field of view.

In at least one embodiment, the tiled image data includes microscopic images and spectroscopic images obtained at substantially the same magnification and substantially the same field of view.

In at least one embodiment, the one or more regions of the composite image are classified as corresponding to at least one of a particle, an intra-particle pore, or an inter-particle void.

In at least one embodiment, the one or more regions of the composite image are classified as corresponding to at least one of clay, alumina, or pores. In at least one embodiment, the microspheric material comprises at least one of alumina or clay-based silica-alumina. In at least one embodiment, the alumina comprises at least one of gibbsite, flash-calcined gibbsite, bayerite, boehmite, or alumina. In at least one embodiment, the clay-based silica-alumina comprises at least one of kaolin clay, hydrous clay, calcined kaolin clay, or sodium silicate.

In at least one embodiment, the particle-classified regions are further classified as comprising at least one of potassium, cesium, calcium, barium, strontium, copper, yttrium, phosphorus, sulfur, selenium, fluorine, chlorine, bromine, iodine, lanthanum, cerium, aluminum, silicon, sodium, carbon, oxygen, iron, vanadium, or nickel.

In at least one embodiment, the particle-classified regions are further classified as at least one of iron, vanadium, or nickel.

In at least one embodiment, the microspheric material is nodulated.

In at least one embodiment, the microspheric material is a fluid catalytic cracking (FCC) catalyst.

In at least one embodiment, the FCC catalyst is an equilibrium catalyst (Ecat).

In at least one embodiment, the microspheric material has an alumina particle crystallinity of between 20% and 50% single boehmite crystal.

In at least one embodiment, the microspheric material has an alumina particle crystallinity of between 20% and 30% single boehmite crystal.

In at least one embodiment, the microspheric material has an alumina particle crystallinity of between 35% and 45% single boehmite crystal.

In at least one embodiment, the microspheric material is embedded in an epoxy resin prior to imaging.

In at least one embodiment, the epoxy resin is polished and carbon-coated prior to imaging.

In at least one embodiment, the machine-learning model is trained to distinguish particles, intra-particle pores, and inter-particle voids using manually-annotated image data as a ground truth reference.

In at least one embodiment, the machine-learning model comprises an artificial neural network.

In at least one embodiment, the machine-learning model comprises a convolutional neural network.

In at least one embodiment, the machine-learning model comprises a recurrent neural network.

The present disclosure also presents systems and computer readable media for performing the disclosed methods.

### BRIEF DESCRIPTION OF THE DRAWINGS

The accompanying drawings, which comprise a part of this specification, illustrate several embodiments and, together with the description, serve to explain the principles disclosed herein. The patent or application file contains at least one drawing executed in color. Copies of this patent or patent application publication with color drawing(s) will be provided by the Office upon request and payment of the necessary fee. In the drawings:

FIG. 1 shows an exemplary System 1000 for performing methods consistent with the present disclosure.

FIG. 2 is a flow chart showing a Method 2000 for training a machine-learning model.

FIG. 3 is a flow chart showing further details of Method 2000 of FIG. 2.

FIG. 4 is a flow chart showing a Method 3000 for classifying one or more characteristics of a microspheric material.

FIG. 5 shows example images produced in Steps 3100, 3300, 3400, and 3500 of Method 3000.

FIG. 6A shows a stitched composite BSE-SEM image of a Sample A color-coded composition prediction by the MAT.

FIG. 6B shows a tiled BSE-SEM image of a Sample A color-coded composition prediction by the MAT.

FIG. 6C shows a tiled EDX ground truth image of FIG. 6B.

FIG. 7 shows a composite image of stitched image tiles of a Sample A color-coded composition prediction by the MAT.

FIG. 8 shows a plot of alumina particle size distribution of Sample A.

FIG. 9A shows a stitched composite BSE-SEM image of a Sample B color-coded composition prediction by the MAT.

FIG. 9B shows a tiled BSE-SEM image of Sample B color-coded composition prediction by the MAT.

FIG. 9C shows a tiled EDX ground truth image of FIG. 9B.

FIG. 10 shows a plot of alumina particle size distribution of Sample B.

FIG. 11A shows a stitched composite BSE-SEM image of a Sample C color-coded composition prediction by the MAT.

FIG. 11B shows a stitched composite BSE-SEM image of a Sample D color-coded composition prediction by the MAT.

FIG. 11C shows a stitched composite BSE-SEM image of a Sample E color-coded composition prediction by the MAT.

FIG. 11D shows a stitched composite BSE-SEM image of a Sample F color-coded composition prediction by the MAT.

FIG. 12 shows a plot of contaminant iron nodulation.

FIG. 13 shows a tiled BSE-SEM image of a Sample C color-coded composition prediction by the MAT.

### DETAILED DESCRIPTION

In this disclosure, the term “catalyst” or “catalyst composition” or “catalyst material” includes, e.g., a material that promotes a reaction. For example, an “oxidation material” promotes an oxidation reaction with one or more components of exhaust gas.

The term “microsphere” includes, e.g., a particle having a diameter of about 1 μm to about 500 μm. Microspheres need not be uniform in size, and may be solid or hollow. A microsphere may contain a matrix having pores.

The term “pore” includes, e.g., an opening or depression in the surface of, or a tunnel in a microsphere. A pore can be a single tunnel or connected to other tunnels in a continuous network throughout the microsphere. Pores may be characterized based on the porosity, pore size, pore volume, surface area, density, pore size distribution, and pore length.

The term “matrix” includes, e.g., the solid material that constitutes an FCC microsphere. The matrix can refer to clay (such as calcined kaolin clay) and/or alumina.

The term “interparticle voids” includes, e.g., the void space in a material, e.g., between microspheres.

The term “very large macropore” includes, e.g., macropores with equivalent diameter larger than 1 micron.

The term “large macropore” includes, e.g., macropores that are larger than 0.5 microns.

The term “zeolite” includes, e.g., a crystalline material which may in particulate form in combination with one or more promoter metals to be used as catalysts. Zeolites are materials based on an extensive three-dimensional network of oxygen ions containing generally tetrahedral-type sites and having a substantially uniform pore distribution, with a substantially uniform pore size no larger than 20 Å. Zeolites include, e.g., aluminosilicates, aluminophosphates, ferrisilicates, and silicaaluminophosphates. The term “aluminophosphates” refers to a specific example of a molecular sieve, including aluminum and phosphate atoms. Aluminophosphates are crystalline materials having rather uniform pore sizes. Listed examples do not encompass all possible zeolitic materials.

The term “about” or “approximately” allows a 5% deviation from the given value. Alternatively, the term “about” includes the standard deviation or variance for a given value, if available.

The term “free of” includes that the material has less than 5% of the recited element. In some embodiments, the material may have less than 3% of the recited element.

The systems and methods described herein may be implemented with respect to a wide range of microspheric materials. In some implementations, for example, the microspheric material may be an FCC catalyst. The catalyst may comprise, e.g., a zeolite, clay, and a binder with or without phosphorous or alumina. In some embodiments, the binder is chosen from a colloidal silica, a peptized alumina, aluminum phosphate, and combinations thereof. In some embodiments, the microspheres comprise clay and a zeolite. In other implementations, the microspheric material may be a material not yet subject to in situ crystallization. In some embodiments the microspheric material may be nodulated. In some embodiments the FCC catalyst may be an equilibrium catalyst (Ecat).

In some embodiments the microspheric material comprises at least one of alumina or clay-based silica-alumina. In some embodiments the alumina comprises at least one of gibbsite, bayerite, flash-calcined gibbsite, boehmite, or alumina. In some embodiments the clay-based silica-alumina comprises at least one of kaolin clay, hydrous clay, calcined kaolin clay, or sodium silicate. In some embodiments the particle-classified regions are further classified as comprising at least one of aluminum, silicon, sodium, carbon, oxygen, iron, vanadium, or nickel. In some embodiments, the compositions of the present disclosure comprise microspheres comprising macropores having an equivalent diameter larger than 1 micron. In some embodiments, the macropores have an equivalent diameter ranging from about 1 micron to about 30 microns, such as from about 1 micron to about 10 microns, such as from about 1 micron to about 20 microns, such as from about 1 micron to about 30 microns, such as from about 2 microns to about 30 microns, such as from about 2 microns to about 10 microns, such as from about 2 microns to about 20 microns, such as from about 2 microns to about 30 microns, such as from about 5 microns to about 10 microns, such as from about 5 microns to about 15 microns, such as from about 5 microns to about 20 microns, such as from about 5 microns to about 25 microns, such as from about 5 microns to about 30 microns, such as from about 10 microns to about 12 microns, such as from about 10 microns to about 14 microns, such as from about 10 microns to about 16 microns, such as from about 10 microns to about 18 microns, such as from about 10 microns to about 20 microns, such as from about 10 microns to about 22 microns, such as from about 10 microns to about 24 microns, 10 microns to about 26 microns, such as from about 10 microns to about 28 microns, such as from about 10 microns to about 30 microns.

In some embodiments, the compositions of the present disclosure comprise very large macropores larger than 10 microns. In some embodiments, the fraction of macropores larger than 10 microns ranges from about 50 ppm to about 1850 ppm, such as from about 100 ppm to about to 1850 ppm, such as from about 150 ppm to about to 1850 ppm, such as from about 200 ppm to about to 1850 ppm, such as from about 250 ppm to about to 1850 ppm, such as from about 300 ppm to about to 1850 ppm, such as from about 350 ppm to about to 1850 ppm, such as from about 400 ppm to about to 1850 ppm, such as from about 450 ppm to about to 1850 ppm, such as from about 500 ppm to about to 1850 ppm, such as from about 600 ppm to about to 1850 ppm, such as from about 650 ppm to about to 1850 ppm, such as from about 700 ppm to about to 1850 ppm, such as from about 750 ppm to about to 1850 ppm, such as from about 800 ppm to about to 1850 ppm, such as from about 850 ppm to about to 1850 ppm, such as from about 900 ppm to about to 1850 ppm, such as from about 950 ppm to about to 1850 ppm, such as from about 1000 ppm to about to 1850 ppm, such as from about 1050 ppm to about to 1850 ppm, such as from about 1100 ppm to about to 1850 ppm, such as from about 100 ppm to about to 1850 ppm, such as from about 100 ppm to about to 1850 ppm, such as from about 1150 ppm to about to 1850 ppm, such as from about 1200 ppm to about to 1850 ppm, such as from about 1250 ppm to about to 1850 ppm, such as from about 1300 ppm to about to 1850 ppm, such as from about 1350 ppm to about to 1850 ppm, such as from about 1400 ppm to about to 1850 ppm, such as from about 1450 ppm to about to 1850 ppm, such as from about 1500 ppm to about to 1850 ppm, such as from about 1550 ppm to about to 1850 ppm, such as from about 1600 ppm to about to 1850 ppm, such as from about 1650 ppm to about to 1850 ppm, such as from about 1700 ppm to about to 1850 ppm, such as from about 1750 ppm to about to 1850 ppm, such as from about 1800 ppm to about to 1850 ppm.

In some embodiments the compositions of the present disclosure comprise microspheres comprising very large macropores characterized by mean pore area. In some embodiments, the macropores have a mean pore area ranging from about 0.2 μm² to about 2.0 m², such as from about 0.3 μm² to about 2.0 μm², such as from about 0.4 μm² to about 2.0 μm², such as from about 0.5 μm² to about 2.0 μm², such as from about 0.6 μm² to about 2.0 μm², such as from about 0.7 μm² to about 2.0 μm², such as from about 0.8 μm² to about 2.0 μm², such as from about 0.9 μm² to about 2.0 μm², such as from about 1.0 μm² to about 2.0 μm², such as from about 1.1 μm² to about 2.0 μm², such as from about 1.2 μm² to about 2.0 μm², such as from about 1.3 μm² to about 2.0 μm², such as from about 1.4 μm² to about 2.0 μm², such as from about 1.5 μm² to about 2.0 μm², such as from about 1.6 μm² to about 2.0 μm², such as from about 1.7 μm² to about 2.0 μm², such as from about 1.8 μm² to about 2.0 μm², such as from about 1.9 μm² to about 2.0 μm².

In some embodiments the compositions of the present disclosure comprise microspheres comprising very large macropores characterized by mean porosity. In some embodiments, the macropores have a mean porosity ranging from about 5% to about 21%, such as from about 6% to about 21%, such as from about 7% to about 21%, such as from about 8% to about 21%, such as from about 9% to about 21%, such as from about 10% to about 21%, such as from about 11% to about 21%, such as from about 12% to about 21%, such as from about 13% to about 21%, such as from about 14% to about 21%, such as from about 15% to about 21%, such as from about 16% to about 21%, such as from about 17% to about 21%, such as from about 18% to about 21%, such as from about 19% to about 21%, such as from about 20% to about 21%.

In some embodiments the compositions of the present disclosure comprise microspheres comprising large macropores characterized by d₉₀. In some embodiments, the macropores have a d₉₀ ranging from about 0.5 to about 1.1 μm, such as from 0.6 to about 1.1 μm, such as from 0.7 to about 1.1 μm, such as from 0.8 to about 1.1 μm, such as from 0.9 to about 1.1 μm, such as from 1.0 to about 1.1 μm, such as from about 0.5 to about 0.7 μm, such as from 0.5 to about 0.9 μm, such as from 0.6 to about 0.8 μm, such as from 0.8 to about 1.0 μm.

In some embodiments the compositions of the present disclosure comprise microspheres comprising single boehmite crystals and kaolin clay. In some embodiments, the microspheres have an alumina particle crystallinity ranging from about 20% to about 50% single boehmite crystals, such as from about 20% to about 30%, such as from about 35% to about 45%.

In some embodiments the compositions of the present disclosure comprise microspheres comprising single boehmite crystals, agglomerate boehmite crystals, and kaolin clay. In some embodiments, the boehmite crystals have a d₅₀ ranging from about 70 nm to about 500 nm, such as from about 70 nm to about 100 nm, such as from about 80 nm to about 90 nm, such as from about 300 nm to about 500 nm, such as from about 350 nm to about 450 nm.

The aluminosilicates may have an open 3-dimensional framework structures composed of corner-sharing TO4 tetrahedra, where T is Al or Si, or optionally P. Cations that balance the charge of the anionic framework are loosely associated with the framework oxygens, and the remaining pore volume is filled with water molecules. The non-framework cations are generally exchangeable, and the water molecules are generally removable.

Any type of molecular sieve can be used, such as structure types of ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AWO, AWW, BCT, BEA, BEC, BIK, BOG, BPH, BRE, CAN, CAS, SCO, CFI, SGF, CGS, CHA, CHI, CLO, CON, CZP, DAC, DDR, DFO, DFT, DOH, DON, EAB, EDI, EMT, EON, EPI, ERI, ESV, ETR, EUO, FAU, FER, FRA, GIS, GIU, GME, GON, GOO, HEU, IFR, IHW, ISV, ITE, ITH, ITW, IWR, IWW, JBW, KFI, LAU, LEV, LIO, LIT, LOS, LOV, LTA, LTL, LTN, MAR, MAZ, MEI, MEL, MEP, MER, MFI, MFS, MON, MOR, MOZ, MSO, MTF, MTN, MTT, MTW, MWW, NAB, NAT, NES, NON, NPO, NSI, OBW, OFF, OSI, OSO, OWE, PAR, PAU, PHI, PON, RHO, RON, RRO, RSN, RTE, RTH, RUT, RWR, RWY, SAO, SAS, SAT, SAV, SBE, SBS, SBT, SFE, SFF, SFG, SFH, SFN, SFO, SGT, SOD, SOS, SSY, STF, STI, STT, TER, THO, TON, TSC, UEI, UFI, UOZ, USI, UTL, VET, VFI, VNI, VSV, WIE, WEN, YUG, ZON, or combinations thereof.

In some embodiments, the zeolite is selected from the group consisting of faujasite (Y, USY, REO-Y), ZSM-5, Beta, FER, ZSM-11, ZSM-22, ZSM-35, MSM-68, chabazite and combinations thereof. In some embodiments, the zeolite is modified by an element. In at least one embodiment, the element is selected from the group consisting of phosphorus and transition metals (Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Hafnium, Tantalum, Tungsten, Rhenium, Osmium, Iridium, Platinum, Gold, Mercury).

The zeolite may also include, e.g., compositions of aluminosilicate, borosilicate, gallosilicate, MeAPSO, and MeAPO. The zeolite can be a natural or synthetic zeolite such as faujasite, chabazite, clinoptilolite, mordenite, silicalite, zeolite X, zeolite Y, ultrastable zeolite Y, ZSM-5, ZSM-12, SSZ-3, SAPO 5, offretite, or a beta zeolite. In one or more specific embodiments, the zeolite is selected from Type A, chabazite, erionite, ZSM-5, ZSM-11, ZSM-23, ZSM-48, ferrierite, stilbite, faujasite, mordenite, Type L, Omega, beta, AlPO4, borosilicates, MeAPO, MeAPSO, and SAPO. In some embodiments, the molecular sieve has a BEA structure type.

The term “binder” includes, e.g., a compound which imparts adhesion and/or cohesion between the zeolitic material particles to be bonded which goes beyond the physisorption which may be present without a binder. The binder can be, e.g., colloidal silica, a peptized alumina, aluminum phosphate, and combinations thereof.

### System

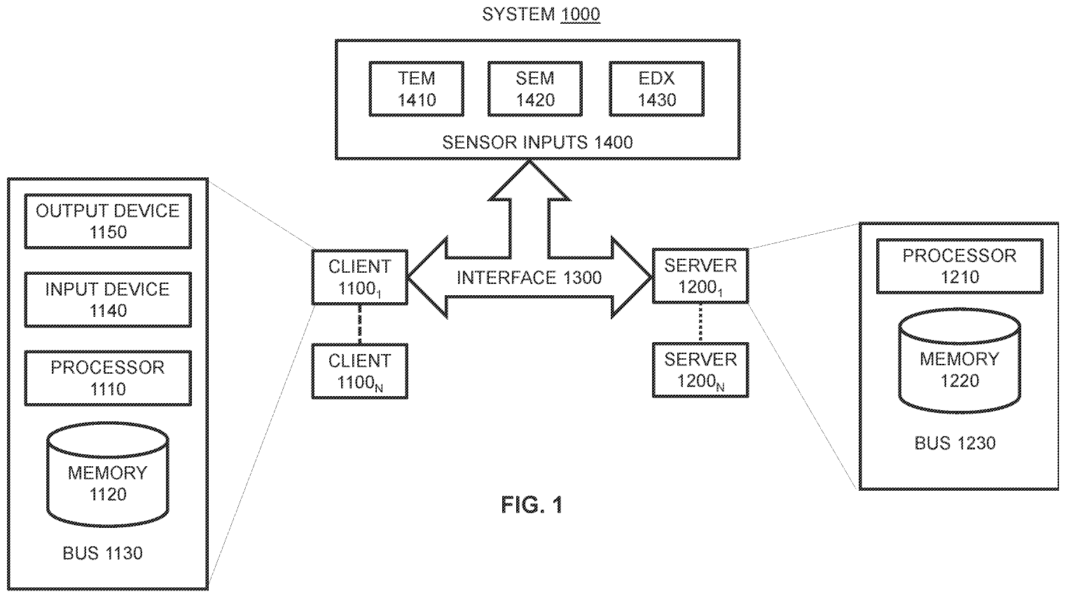

FIG. 1 shows an exemplary system 1000 for performing methods consistent with the present disclosure.

As shown in FIG. 1, system 1000 may be implemented using a client/server architecture, including one or more client-side processing devices 11001-N executing user applications, and one or more server-side processing devices 12001-N executing server applications. The client-side processing device(s) 1100 may communicate with the server-side processing device(s) 1200 via an electronic interface 1300, e.g., a wired and/or wireless communication interfaces, such as a wide-area network (WAN) interface, a local area network (LAN) interface, or the Internet. Alternatively, system 1000 may be implemented as a stand-alone processing device, e.g., processing device 11001.

The client-side processing device(s) 1100 may be implemented as thin clients or thick clients, e.g., using personal computers, server terminals, mobile devices, etc., and may take the form of, e.g., desktop, laptop, or hand-held devices. As shown in FIG. 1, the client-side processing device(s) 1100 may each include one or more processing units 1110 and memories 1120 operatively coupled by a bus 1130.

Processing unit 1110 may include one or more processors (e.g., microprocessors) programmed to perform methods consistent with this disclosure and associated hardware, software, and/or hardwired logic circuitry. The processors may operate singly or in parallel. Memory 1120 may include non-transitory computer-readable media, e.g., both read-only memory (ROM) and random-access memory (RAM). At various times, computer-readable instructions, data structures, program modules, and data necessary for execution of the methods disclosed herein may be stored in ROM and/or RAM portions of memory 1120. In particular, memory 1120 may store an operating system, one or more client-side application programs (e.g., computer or mobile applications programs) and/or program modules, and program data. Bus 1130 may include a memory bus or memory controller, a peripheral bus, and a local bus, each implemented using any of a variety of bus architectures.

The client-side processing device(s) 1100 may each also include one or more user input devices 1140 and output devices 1150. The output devices may include, e.g., a monitor, display, speaker, and/or printer for outputting information to a user. User input devices 1140 may include, e.g., a keyboard, microphone, scanner, and/or a pointing device, such as a mouse or touchscreen, for entering commands or data in cooperation with a graphical user interface displayed on a display or monitor.

The server-side processing device(s) 1200 may be implemented using personal computers, network servers, web servers, file servers, etc. As shown in FIG. 1, the server-side processing device(s) 1200 may each include one or more processing units 1210 and memories 1220 operatively coupled by a bus 1230.

Processing unit 1210 may include one or more processors (e.g., microprocessors) programmed to perform methods consistent with this disclosure and associated hardware, software, and/or hardwired logic circuitry. The processors may operate singly or in parallel. Memory 1220 may include non-transitory computer-readable media, e.g., both read-only memory (ROM) and random-access memory (RAM). At various times, computer-readable instructions, data structures, program modules, and data necessary for execution of the methods disclosed herein may be stored in ROM and/or RAM portions of memory 1220. In particular, memory 1220 may store an operating system, one or more server-side application programs and/or program modules, and program data. Bus 1230 may include a memory bus or memory controller, a peripheral bus, and a local bus, each implemented using any of a variety of bus architectures.

In some implementations, system 1000 may further include one or more sensor inputs 1400 for providing data needed to perform methods consistent with this disclosure. The sensor inputs may include laboratory and/or test equipment for gathering such data, such as a transmission electron microscope (TEM) 1410, scanning electron microscope (SEM) 1420, and/or an energy dispersive X-ray spectrometer (EDX) 1430. Sensor inputs 1400 may further include inputs for associated TEM, SEM, and EDX techniques, such as cross-sectional TEM, cross-sectional SEM, or backscattered electron scanning electron microscopy (BSE-SEM).

### Training the Machine-Learning Model

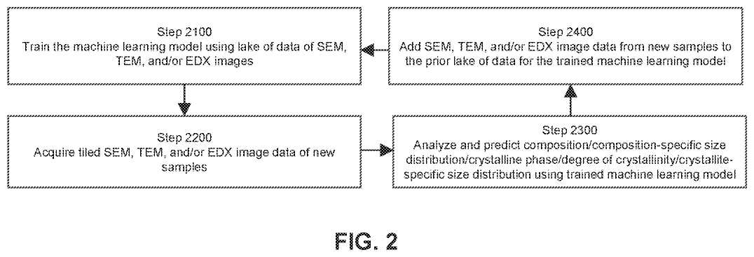

FIG. 2 is a flow chart broadly showing a method 2000 for training a machine-learning model for classifying one or more regions, and characterizing the one or more of the composition, composition-specific size distribution, or crystalline phase distribution, degree of crystallinity, or crystallite-specific size distribution of particle-classified regions of a microspheric material. Method 2000 may be implemented by executing computer-readable instructions, data structures, and/or program modules stored in memories 1120 and/or 1220.

In Step 2100, a machine-learning model may be trained using a lake of data gathered from a first set of microscopic and/or spectroscopic images. For example, the data may be gathered using one or more sensor inputs, such as TEM 1410, SEM 1420, and/or EDX 1430. The data lake may be stored in one or more of memories 1120 and/or 1220 and may further be distributed across multiple such memories. The machine-learning module may be trained and executed using one or more of server-side processing devices 1200, by one or more client-side processing devices 1100, or a combination of such devices operating serially and/or in parallel.

In Step 2200, microscopic and/or spectroscopic images data from a new sample to be analyzed are acquired. For example, the data may be gathered using the same or different inputs as Step 2100, such as TEM 1410, SEM 1420, and/or EDX 1430.

In Step 2300, the classification of image regions and characterization of one or more of the composition, composition-specific size distribution, or crystalline phase distribution, degree of crystallinity, or crystallite-specific size distribution of particle-classified regions of a microspheric material is predicted using the trained machine-learning model. For example, the analysis may be determined by the trained machine-learning model operating on one or more of server-side processing devices 1200, on one or more client-side processing devices 1100, or a combination of such devices operating serially and/or in parallel and output to the user using an output device 1150, such as a display or printer.

In Step 2400, the classification and characterization data from the new sample is added to the data lake for training future machine-learning models.

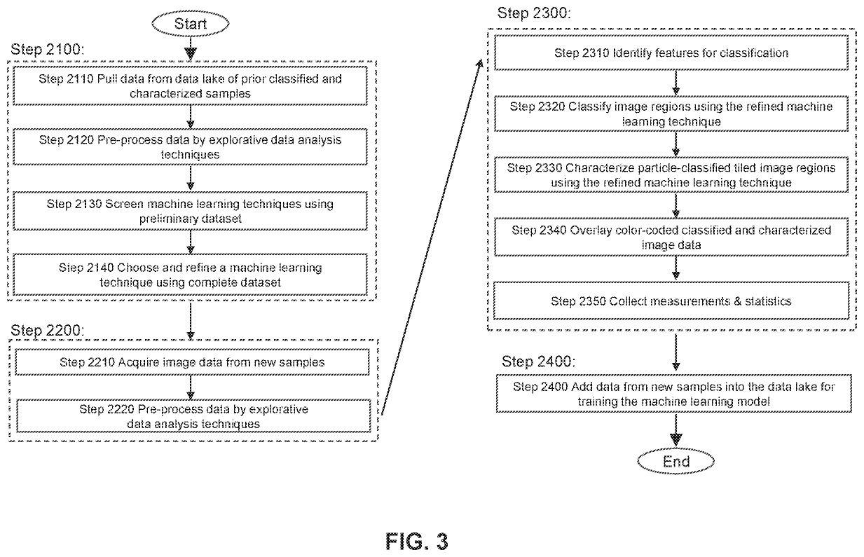

FIG. 3 is a flow chart showing the Method 2000 of FIG. 2 in more detail. In particular, FIG. 3 shows certain sub-steps that may be performed within Steps 2100 to 2400. As shown in FIG. 3, a machine-learning model is trained using a lake of data gathered from a first set of TEM, SEM, and/or EDX images (Step 2100). TEM, SEM, and/or EDX image data of a new sample are acquired (Sub-Step 2210). Images may be preprocessed (such as cropping) and machine-learning techniques are applied to these images for semantic segmentation (Sub-Step 2220). Individual pixels are categorized according to the pool of pre-determined key features during training and uniquely colorized based on these key features. Neighboring pixels of the same feature are grouped together as objects that can be extracted for measurements (Sub-Steps 2310-2340). Measurements of every object in every feature class provide statistical analysis (Sub-Step 2350). Collected data from new samples can then be added into the data lake for future machine-learning model training. (Step 2400).

In Step 2200, system 1000 may extract training data comprising one or more TEM, SEM, and/or EDX images and identify parameters or features from each image, such that each parameter or feature is collected from each respective image in the plurality of samples. For example, the system may extract a set of training data as described above in conjunction with FIGS. 2-3.

In Step 2300, the training data may be classified in accordance with at least one structural, elemental, or physical characteristics described in the training data. For example, the training data may be classified in accordance with an identification of pores, or interparticle voids, or the detection of alkali metals (such as but not limited to sodium, potassium, cesium), alkaline earth metals (such as but not limited to calcium, barium, strontium), transition metals (such as but not limited to iron, nickel, copper, yttrium, and vanadium), post-transition metals (such as but not limited to aluminum), metalloids (such as but not limited to silicon), non-metal elements (such as phosphorus, sulfur, selenium, and halogens), and actinides and lanthanides (such as but not limited to lanthanum or cerium).

In Step 2300, the system may generate a machine-learning model, which may be trained based on the chosen features or parameters, to predict compositional and/or structural properties of a FCC catalyst. The machine-learning model may be trained using supervised or unsupervised training techniques.

Supervised learning allows for prediction based on the data model that may be generated from the training set. Suitable supervised learning techniques may include, e.g., Deep Learning, Suitable supervised learning techniques may include, e.g., Artificial Neural Networks, Convolutional Neural Network, Recurrent Neural Network, Support Vector Machine, Linear Discriminant Analysis, and Logistic Regression techniques. Other suitable supervised and unsupervised learning techniques may be used, such as Bayesian Net Genetic Algorithms/Genetic Programming, Simulated Annealing, Tangled Hierarchies of Sets, Recursive Partitioning, Clustering, Hidden Markov Models, Fuzzy Methods, Semantic Networks, Naïve Bayes Similarity Mapping, Support Vector Machines, Self-organizing Maps, and Gaussian Process techniques. In some embodiments the supervised and unsupervised learning model may be trained to distinguish particles, intra-particle pores, and inter-particle voids using manually-annotated image data as a ground truth reference.

### Microsphere Analysis Tool (MAT)

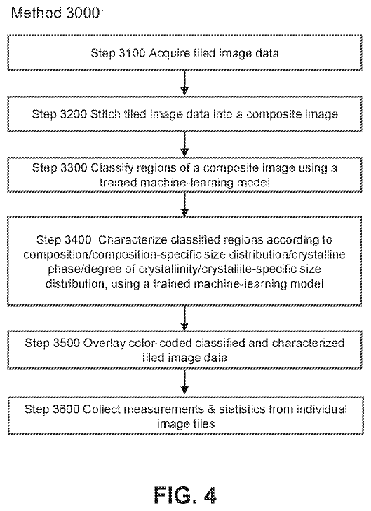

FIG. 4 is a flow chart showing a Method 3000 for acquiring and characterizing microspheric materials based on image data. As shown in FIG. 3, microscopic and spectroscopic image data is acquired in a plurality of image tiles (Step 3100). The tiled image data may be two- or three-dimensional image data acquired with substantially the same acceleration voltage, at substantially the same magnification level and working distance or field-of-view, and substantially the same dwell time. In some embodiments, tiles can be acquired at a high magnification, which may increase resolution within a specific field of view.

In some embodiments, the microspheric material may be embedded in an epoxy resin, which may be polished and carbon-coated prior to imaging. Once the sample is placed, the tiled image data may be acquired in a fully- or partially-automated process, or in an unsupervised process. For example, the sample and/or the sensor may be configured to move relative to each other, in order to collect a plurality of image tiles acquired by grid segmentation in a row-column pattern.

In some embodiments the tiled image data is acquired at a fixed magnification. In some embodiments, the fixed magnification is in a range of about 100× to about 6,000×, such as from about 100× to about 1,000×, such as from about 250× to about 550×, such as from about 1,000× to about 6,000×, such as from about 4,000× to about 5,500×. In some embodiments, the fixed magnification is in a range of about 20,000× to about 500,000×, such as from about 20,000× to about 50,000×, such as from about 20,000× to about 40,000×, such as from about 20,000× to about 30,000×, such as from about 100,000× to about 500,000×, such as from about 250,000× to about 500,000×, such as from about 400,000× to about 500,000×.

To minimize unimaged sample regions, tiles overlap in two directions (horizontally and vertically) relative to adjacent tiles. For example, the image tiles may overlap in a range between about 5% and 20%, about 10% to 20%, or about 15% to 20% in the horizontal and vertical directions. The amount of overlap in the horizontal and vertical directions may or may not be the same.

To avoid double-counting of overlapped area in the statistical analysis, adjacent tiles are stitched together to form a mosaic or composite image (Step 3200). %. For example, the tiles may be stitched using the Microscopy Image Stitching Tool (MIST) application developed by the National Institute of Standards and Technology (NIST) for the ImageJ/Fiji imaging software suite, in order to reduce processing time and errors in the mosaic image.

Regions of the composite image may then be segmented and classified using a trained machine-learning model (Step 3300). For example, the machine-learning model may be trained using techniques set forth in U.S. Application No. 63/203,217, which is incorporated herein by reference in its entirety. In some embodiments, regions may be classified as one of a particle, an intra-particle pore, or an inter-particle void. Particle-classified regions can be further characterized using a trained machine-learning model according to one or more of the composition, composition-specific size distribution, crystalline phase, degree of crystallinity, or crystallite-specific size distribution (Step 3500). Measurements of classified or characterized features of interest may then be collected and statistically analyzed (Step 3600).

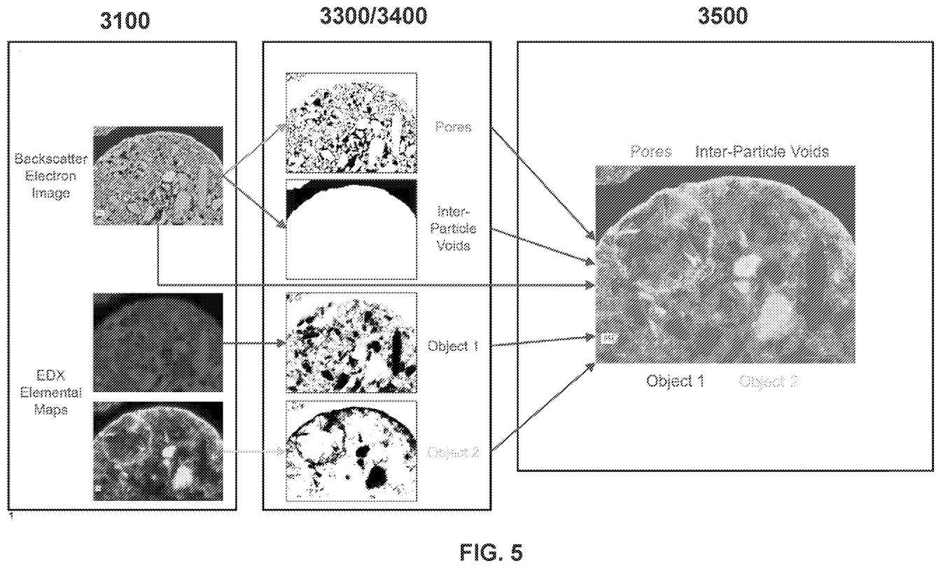

FIG. 5 is a flow chart showing exemplary images produced in steps of Method 3000 for classifying regions and characterizing the compositional and/or structural properties of a microspheric material. In particular, FIG. 5 shows exemplary images of Sub-Steps 3100, 3300, 3400, and 3500, in which BSE-SEM and EDX images have been acquired with the same field of view and magnification.

### Illustrative Examples

The following non-limiting example(s) are set forth to assist in understanding the disclosure and should not, of course, be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein. The following non-limiting examples further illustrate various aspects and features of the disclosed systems and methods and computer readable media.

### Example 1

Autonomous microscopic and spectroscopic image acquisition capability was used in unsupervised overnight sessions to acquire SEM and EDX images, at 5000×, for the entire specimen of Samples A and B.

Samples A and B were prepared by first embedding in epoxy resin, followed by polishing and carbon-coating. The composition of microspheric Samples A and B were prepared according to Table 1. Microspheres of Sample A were composed of 6% boehmite, balance low-iron kaolin clay. Microspheres of Sample B were composed of 6% boehmite, balance low-iron kaolin clay. Mass fractions were reported on a volatile-free basis.

TABLE 1

| Sample | Composition |
|---|---|
| A | 6 wt % boehmite |
| | 94 wt % low-iron kaolin clay |
| B | 18 wt % boehmite |
| | 82 wt % low-iron kaolin clay |

SEM images were collected at a high-pixel resolution of 2,000×1,500 pixels. five hundred epochs of training iterations were conducted to enhance model accuracy in differentiating between particles, intra-particle pores, and inter-particle voids.

The trained artificial intelligence model was then deployed for automated semantic segmentation of four SEM images from each Sample A and B. Once the segmentations were verified for accuracy, recipes and macros were built into a MIPAR environment to measure and quantify compositional and structural attributes of the microspheric material.

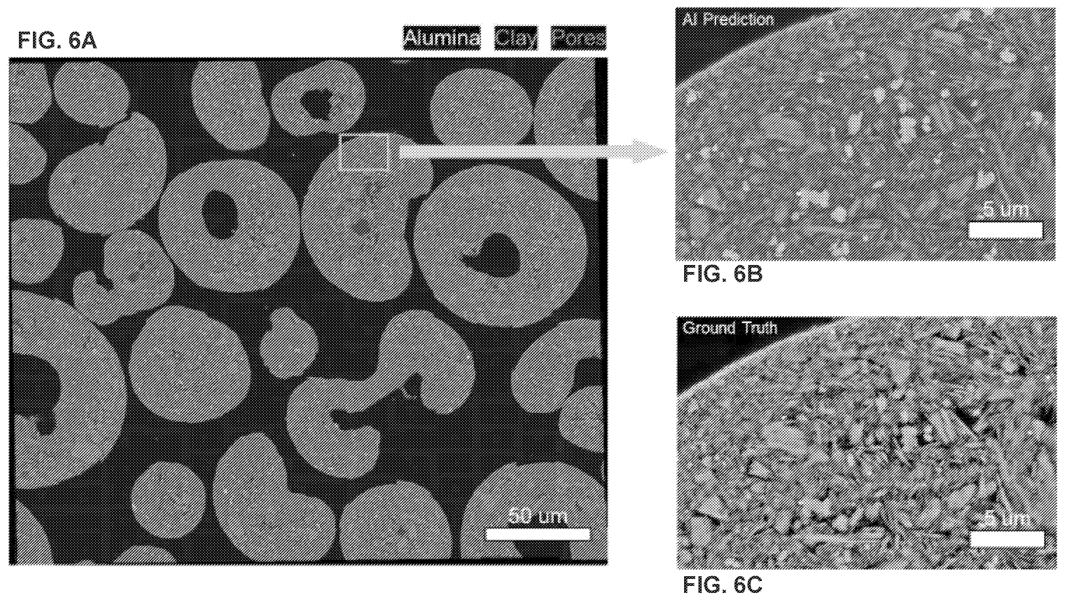

FIG. 6A shows a 300× composite image of 266 tiled SEM images of Sample A, acquired by SEM at a magnification of 5,000× in an unsupervised overnight session. Complementary EDX, acquired in the same field of view and at the same magnification, was obtained to train the machine-learning model. FIG. 6B shows the alumina and clay particles distinguished by the machine-learning model in Sample A, which was compared to FIG. 6C, a ground-truth image of Sample A. In FIG. 6B, alumina regions are colored yellow, clay regions are colored blue, intra-particle pores are colored green, and inter-particle voids are colored black. In FIG. 6C, EDX ground truth alumina regions are colored yellow, clay regions are colored grey, and intra-particle pores and inter-particle voids, are both colored black. Intra-particle pores and inter-particle voids may be further differentiated using different colors based on their classification by the trained machine-learning model as intra-particle pores and inter-particle voids, as shown in FIG. 6B.

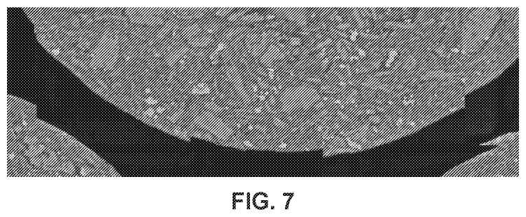

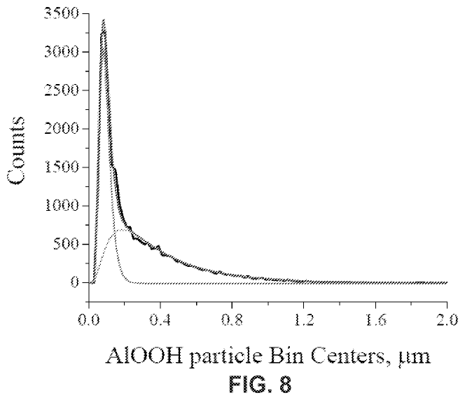

FIG. 7 shows a composite image of Sample A, which was generated by stitching adjacent image tiles. The crystallite size distribution of alumina particles of Sample A is shown in FIG. 8. The alumina size distribution of 26,047 alumina particles was identified as the sum of two log-normal distributions, colored blue. The first log-normal distribution of Sample A, colored red, was attributed to 40% boehmite single crystals with a d₅₀ equal to 89 nm. The second log-normal distribution of Sample A, colored green, was attributed to 60% agglomerates with a d₅₀ equal to 333 nm.

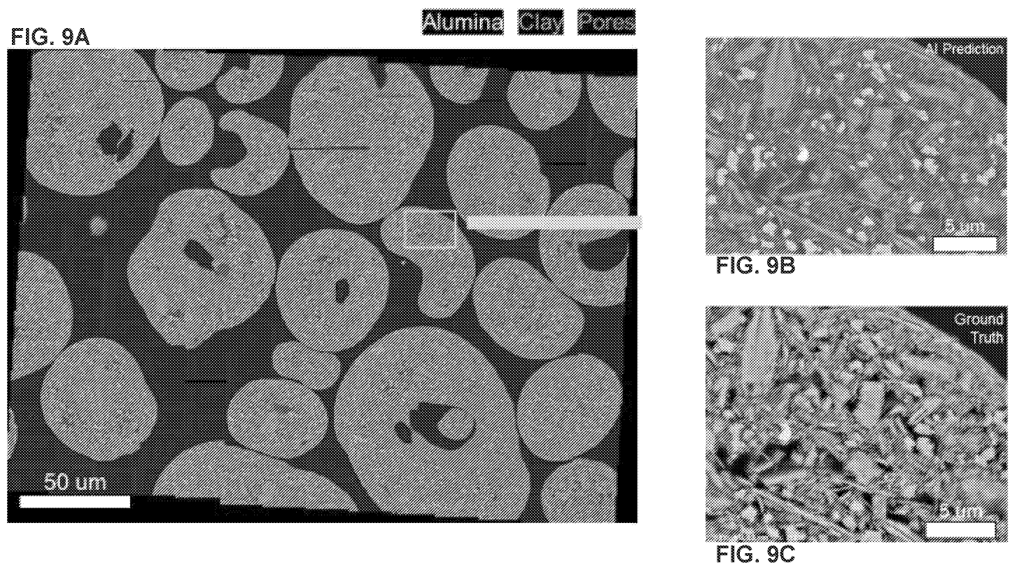

FIG. 9A shows a 300× composite image of 210 tiled SEM images of Sample B, acquired by SEM at a magnification of 5,000× in an unsupervised overnight session. FIG. 9B shows the alumina and clay particles of Sample B, which was compared to FIG. 9C, a ground-truth image of Sample B. In FIG. 9B, alumina regions are colored yellow, clay regions are colored blue, intra-particle pores are colored green, and inter-particle voids are colored black. In FIG. 9C, EDX ground truth alumina regions are colored yellow, clay regions are colored grey, and intra-particle pores and inter-particle voids, both colored black, lack differentiation.

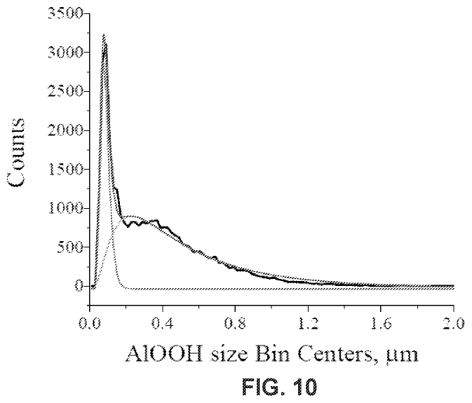

The crystallite size distribution of alumina particles of Sample B is shown in FIG. 10. The alumina size distribution of 33,162 alumina particles was identified as the sum of two log-normal distributions, colored blue. The first log-normal distribution of Sample B, colored red, was attributed to 25% boehmite single crystals with a d₅₀ equal to 83 nm. The second log-normal distribution of Sample B, colored green, was attributed to 75% agglomerates with a d₅₀ equal to 444 nm.

The crystallite size distributions of alumina particles of Samples A and B, as plotted in FIGS. 8 and 10, were further compared to estimated crystallite sizes from X-ray diffraction (not shown). By considering the width of the 120 reflection from the XRD diffractogram in view of the Scherrer equation, the crystallite size of Samples A and B were estimated to be in the range of 80 and 100 nm. In comparing the XRD-estimated crystallite sizes of Samples A and B with the SEM crystallite size distributions determined by the machine-learning model, a substantial minority of alumina particles were accurately captured by XRD analysis (40% of Sample A and 25% of Sample B). In both Samples A and B, the machine-learning model showed a second distribution that was not reflected by conventional methods of characterization.

### Example 2

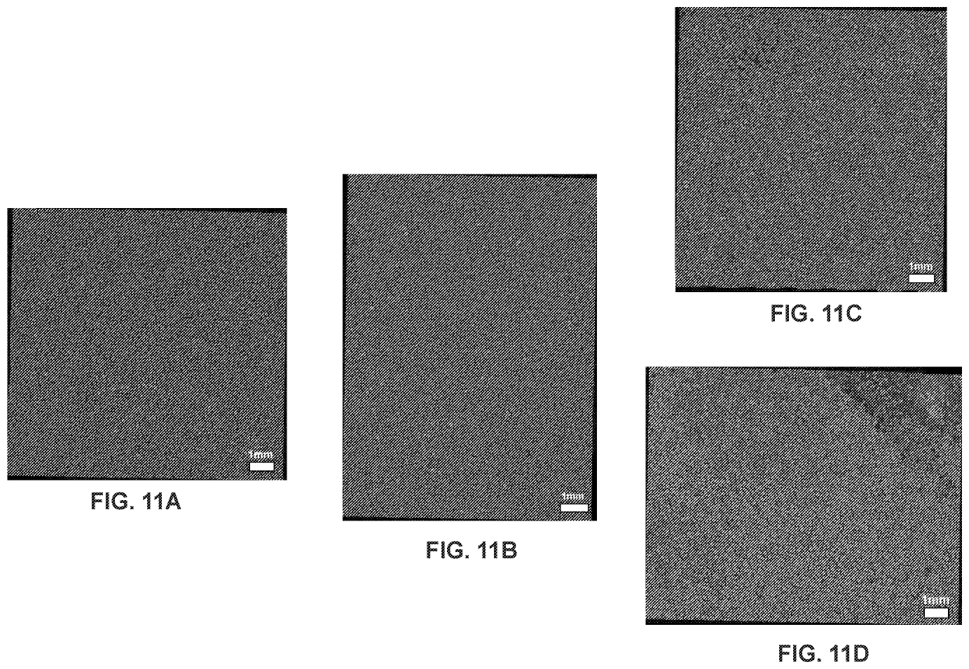

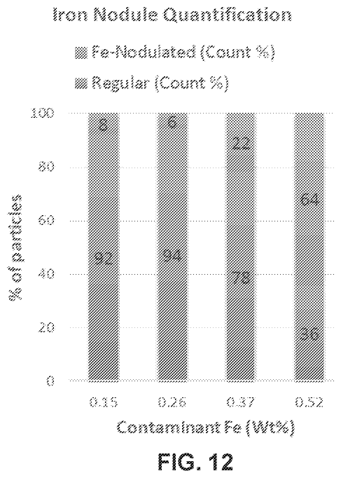

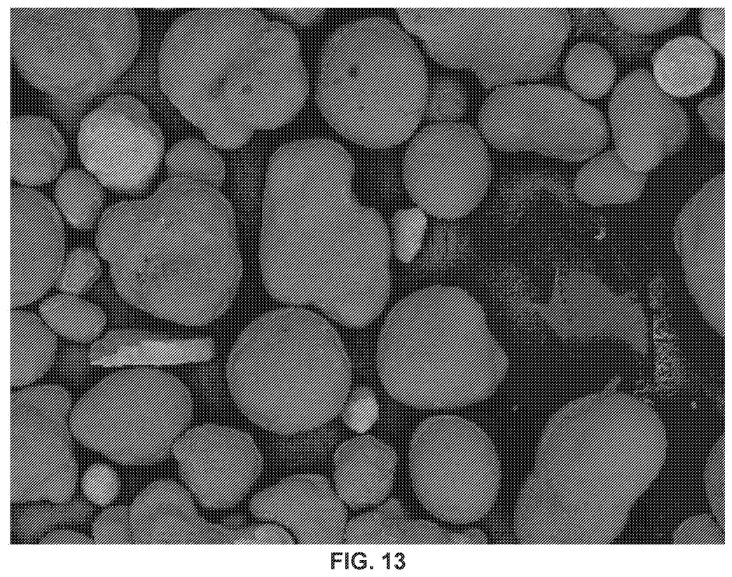

Partially autonomous microscopic and spectroscopic image acquisition capability was used to acquire SEM and EDX images, at 5,000×, for the entire specimen of Samples C, D, E and F (FIGS. 11A-D, Table 2). Each of FIGS. 11A-D is a composite image stitched from overlapping image tiles. FIG. 11A was stitched from 320 image tiles, FIG. 11B was stitched from 220 image tiles, FIG. 11C was stitched from 300 image tiles, and FIG. 11D was stitched from 268 image tiles. A trained machine-learning model classified image regions, and further characterized particle-classified regions according to composition. Specifically, particle-classified regions characterized as iron nodulated particles were colored red, and quantified according to the percentage (%) of particles with nodulated contaminant iron. FIG. 12 shows the resultant quantification by the machine-learning model. Specifically, FIG. 12 shows that as the wt % of contaminant iron increased, the machine-learning model identified that an increasing percentage of particles were partially composed of iron nodules. This was in agreement with the trends observed in FIGS. 11A-D, wherein the qualitative percentage of red particles increased as a function of contaminant iron (wt %). Despite the increasing wt % of contaminant iron, these Samples C, D, E, and F in separate analyses offer comparable catalytic activity, implying that the wt % of contaminant iron deduced from this analysis is not a direct or indirect measure of catalytic performance. FIG. 13 shows an individual image tile of Sample E classified and characterized according to the trained machine-learning model.

SEM images were collected at a high-pixel resolution of 2,000×1,500 pixels, and tiled into 9 sub-frames for training. Three hundred epochs of training iterations were conducted to enhance model accuracy in differentiating between particles, intra-particle pores, and inter-particle voids.

TABLE 2

| | | Contaminant | | |
|---|---|---|---|---|
| Sample | Total Fe, wt % | Fe, wt % | Ni, ppm | V, ppm |
| C | 1.07 | 0.52 | 1309 | 3033 |
| D | 0.92 | 0.37 | 1061 | 2645 |
| E | 0.81 | 0.26 | 1045 | 2751 |
| F | 0.70 | 0.15 | 837 | 2357 |

The foregoing description has been presented for purposes of illustration. It is not exhaustive and is not limited to precise forms or embodiments disclosed. Modifications and adaptations of the embodiments will be apparent from consideration of the specification and practice of the disclosed implementations. For example, while certain components of system 1000 have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various implementations), adaptations or alterations based on the present disclosure. The elements of the claims are to be interpreted broadly based on the language employed in the claims and not limited to examples described in the present Specification or during the prosecution of the Application, which examples are to be construed as nonexclusive. Further, the steps of the disclosed methods can be modified in any manner, including reordering steps or inserting or deleting steps. In particular, non-dependent steps may be performed in any order, or in parallel.

Other embodiments will be apparent from consideration of the specification and practice of the embodiments disclosed herein. It is intended that the specification and examples be considered as example only, with a true scope and spirit of the disclosed embodiments being indicated by the following claims.

1. A method for characterizing microspheric materials comprising:
acquiring tiled image data representative of microscopic images of a microspheric material, spectroscopic images of a microspheric material, or a combination of microscopic and spectroscopic images of a microspheric material;
stitching the tiled image data into a composite image;
classifying, by a trained machine-learning model, one or more regions of the composite image; and
characterizing, by the trained machine-learning model, one or more classified regions of the composite image according to at least one of the following properties:
composition,
composition-specific size distribution,
crystalline phase,
degree of crystallinity, or
crystallite-specific size distribution.

2. The method of claim 1, wherein the tiled image data is obtained by scanning electron microscopy (SEM) and/or by transmission electron spectroscopy (TEM).

3. The method of claim 2, wherein the tiled image data is obtained by cross-sectional scanning electron microscopy or by backscatter electron scanning electron microscopy (BSE-SEM).

4. (canceled)

5. (canceled)

6. (canceled)

7. The method of claim 1, wherein the tiled image data is obtained by energy dispersive X-ray spectroscopy (EDX).

8. The method of claim 1, wherein the tiled image data is two- or three-dimensional image data.

9. (canceled)

10. The method of claim 1, wherein the tiled image data is acquired in a partially automated process, or a fully automated process, or an unsupervised process.

11. (canceled)

12. (canceled)

13. The method of claim 1, wherein the tiled image data is acquired by grid segmentation in a row-column pattern.

14. The method of claim 13, wherein the tiled image data comprises partially overlapping image tiles.

15. (canceled)

16. (canceled)

17. The method of claim 1, wherein the tiled image data is acquired at a magnification between the range of 100× and 6,000×, or at a magnification between the range of 20,000× and 500,000×.

18. (canceled)

19. (canceled)

20. (canceled)

21. (canceled)

22. (canceled)

23. The method of claim 1, wherein the tiled image data includes microscopic images and spectroscopic images obtained at substantially the same magnification and/or obtained at substantially the same field of view.

24. (canceled)

25. (canceled)

26. The method of claim 1, wherein the one or more regions of the composite image are classified as corresponding to at least one of a particle, an intra-particle pore, or an inter-particle void.

27. The method of claim 1, wherein the one or more regions of the composite image are classified as corresponding to at least one of clay, alumina, or pores.

28. The method of claim 27, wherein the microspheric material comprises at least one clay-based silica-alumina or alumina, the alumina optionally comprising at least one of gibbsite, flash-calcined gibbsite, bayerite, or boehmite.

29. (canceled)

30. (canceled)

31. The method of claim 1, wherein the particle-classified regions are further classified as comprising at least one of potassium, cesium, calcium, barium, strontium, copper, yttrium, phosphorus, sulfur, selenium, fluorine, chlorine, bromine, iodine, lanthanum, cerium, aluminum, silicon, sodium, carbon, oxygen, iron, vanadium, or nickel.

32. (canceled)

33. The method of claim 1, wherein the microspheric material is nodulated.

34. The method of claim 1, wherein the microspheric material is a fluid catalytic cracking (FCC) catalyst.

35. (canceled)

36. (canceled)

37. (canceled)

38. (canceled)

39. The method of claim 1, wherein the microspheric material is embedded in an epoxy resin prior to imaging.

40. (canceled)

41. The method of claim 1, wherein the machine-learning model is trained to distinguish particles, intra-particle pores, and inter-particle voids using manually-annotated image data as a ground truth reference.

42. The method of claim 1, wherein the machine-learning model comprises a convolutional neural network or a recurrent neural network.

43. (canceled)

44. (canceled)

45. A system comprising:
at least one processor configured to:
acquire tiled image data representative of microscopic images of a microspheric material, spectroscopic images of a microspheric material, or a combination of microscopic and spectroscopic images of a microspheric material;
stitch the tiled image data into a composite image;
classify, by a trained machine-learning model, one or more regions of the composite image; and
characterize, by the trained machine-learning model, one or more classified regions of the composite image according to at least one of the following properties:
composition,
composition-specific size distribution,
crystalline phase,
degree of crystallinity, or
crystallite-specific size distribution.

46. The system of claim 45, wherein the system is configured to perform the method of claim 1.

47. A non-transitory computer-readable medium having instructions encoded thereon that, when executed by at least one processor, cause the at least one processor to:
acquire tiled image data representative of microscopic images of a microspheric material, spectroscopic images of a microspheric material, or a combination of microscopic and spectroscopic images of a microspheric material;
stitch the tiled image data into a composite image;
classify, by a trained machine-learning model, one or more regions of the composite image; and
characterize, by the trained machine-learning model, one or more classified regions of the composite image according to at least one of the following properties:
composition,
composition-specific size distribution,
crystalline phase,
degree of crystallinity, or
crystallite-specific size distribution.

48. The non-transitory computer-readable medium of claim 47, wherein the instructions further cause the at least one processor to perform the method of claim 1.
